(19) United States
(12) Patent Application Publication
(10) Pub. No.: US 2015/0092524 A1
(43) Pub. Date: Apr. 2, 2015

(54) CERAMIC ELEMENT INLAID WITH AT LEAST ONE CERAMIC DECORATION

(71) Applicant: Montres Rado SA, Lengnau (CH)

(72) Inventor: Christian VERDON, Boussens (CH)

(73) Assignee: Montres Rado SA, Lengnau (CH)

(21) Appl. No.: 14/487,551

(22) Filed: Sep. 16, 2014

(30) Foreign Application Priority Data
Oct. 1, 2013 (EP) 13186826.7

(51) Int. Cl. G04B 45/00; C23D 5/00

(52) U.S. Cl. CPC G04B 45/0076; C23D 5/005
USPC 368/285; 216/39

(57) ABSTRACT

The invention relates to a method of manufacturing an inlaid ceramic element for a timepiece comprising the following steps:
a) forming a ceramic body;
b) etching at least one recess in one face of the ceramic body, each at least one recess forming the pattern cavity for a decoration;
c) changing the surface state of the bottom of said at least one recess in order to increase the contact surface thereof;
d) depositing, by thermal spraying, a second ceramic material above said at least one recess in order to totally fill said at least one recess;
e) flattening said second ceramic material so that said second ceramic material remains only in the hollow of said at least one recess.

This applications claims priority from European Patent Application No. 13186826.7 filed Oct. 1, 2013, the entire disclosure of which is hereby incorporated herein by reference.

### FIELD OF THE INVENTION

The invention relates to a ceramic element inlaid with at least one decoration made of another ceramic material and more specifically an element of this type intended to be mounted in a timepiece.

### BACKGROUND OF THE INVENTION

It is known to form watch bezels at least partially made of synthetic sapphire in order to show, by means of transparency, a deposition in a recess underneath the bezel, for example, forming a graduation or a brand name. This configuration has the advantage of protecting the deposition from any mechanical degradation by totally covering it with the sapphire part. However, this configuration may make the decoration difficult to read due to impaired transmission of the colour of the deposition but also due to the lack of colour difference between sapphire and the deposition.

### SUMMARY OF THE INVENTION

It is an object of the invention to overcome all or part of the aforementioned drawbacks by proposing a totally ceramic element, i.e. whose main body and inlaid elements enjoy homogeneous mechanical resistance.

To this end, the invention relates to a method of manufacturing an inlaid ceramic element for a timepiece including the following steps:
a) forming a ceramic body;
b) etching at least one recess in one face of the ceramic body, each at least one recess forming the pattern for a decoration;
c) changing the surface state of the bottom of said at least one recess in order to increase the contact surface thereof;
d) depositing, by thermal spraying, a second ceramic material above said at least one recess in order to totally fill said at least one recess;
e) flattening said second ceramic material so that it remains only in the hollow of said at least one recess.

It is immediately clear that the variety of colours of the decoration and/or of the body is no longer limited by the transparency of the second ceramic material, and yet very high and homogenous wear resistance is obtained. By way of example, it is therefore possible to obtain a highly contrasted visual rendering with the body made of a first, dark-coloured ceramic material and decorations made of one (or more) other ceramic(s) material(s) in one (or more) light colours.

In accordance with other advantageous features of the invention:
step a) is achieved by sintering;
the ceramic body includes a carbide, an oxide or a nitride of materials such as titanium, silicon, aluminium or zirconium;
the ceramic body is a cermet;
the ceramic body is a synthetic corundum such as single crystal sapphire or a single crystal ruby;
step b) is performed by laser;
each at least one recess has a depth comprised between 80 μm and 500 μm to improve the force of adherence;
step c) is performed by laser;
step c) forms cavities in said bottom of said at least one recess;
the cavities form grooves running on said bottom of said at least one recess;
said grooves running on said bottom of said at least one recess are secant;
the cavities have depths which are less than one fifth of the depth of said at least one recess;
step c) is performed by sandblasting or chemical etching;
the second ceramic material includes a carbide, an oxide or a nitride of materials such as titanium, silicon, aluminium or zirconium;
the thermal spraying is of the plasma type;
prior to step d), the method includes step f) intended to form a connecting layer on the bottom of said at least one recess in order to ensure improved adherence or to change the aesthetic appearance of the second ceramic material;
after step e), the method includes step b′) intended to etch at least a second recess in a face of the second ceramic material, step c′) intended to change the surface state of the bottom of said at least one second recess in order to increase the contact surface thereof; step d′) intended to deposit, by thermal spraying, a third ceramic material above said at least one second recess in order to totally fill said at least one second recess, and step e′) intended to flatten said third ceramic material so that it remains only in the hollow of said at least one second recess.

Moreover, the invention relates to a part of the exterior of a timepiece, to a part of the movement of a timepiece or more generally to a timepiece, characterized in that it includes at least one ceramic element inlaid with a decoration formed by at least a second ceramic material according to any of the preceding variants.

Advantageously, it is therefore clear that the ceramic element may equally form all or part of a case, a bracelet, a bezel, a dial, a crystal, a push-piece, a crown, a watch middle part, a horn, a flange, a back cover of a case, a hand, a link, a clasp, a decoration, an applique, a balance spring, an impulse pin, a balance, a staff, a roller, pallets, a pin, a pallet-lever, a fork, a pallet-stone, a dart, a wheel set, a wheel, an arbor, a pinion, a bridge, a main plate, an oscillating weight, a winding stem, a bearing-block or a bearing of a watch.

### BRIEF DESCRIPTION OF THE DRAWINGS

Other features and advantages will appear clearly from the following description, given by way of non-limiting illustration, with reference to the annexed drawings, in which:

FIG. 1 is a diagram of a timepiece according to the invention;

FIGS. 2 to 4 are successive steps of the manufacturing method according to the invention;

FIG. 5 is a partial view of an element obtained according to the invention;

FIG. 6 is a flow diagram of the method according to the invention.

### DETAILED DESCRIPTION OF PREFERRED EMBODIMENTS

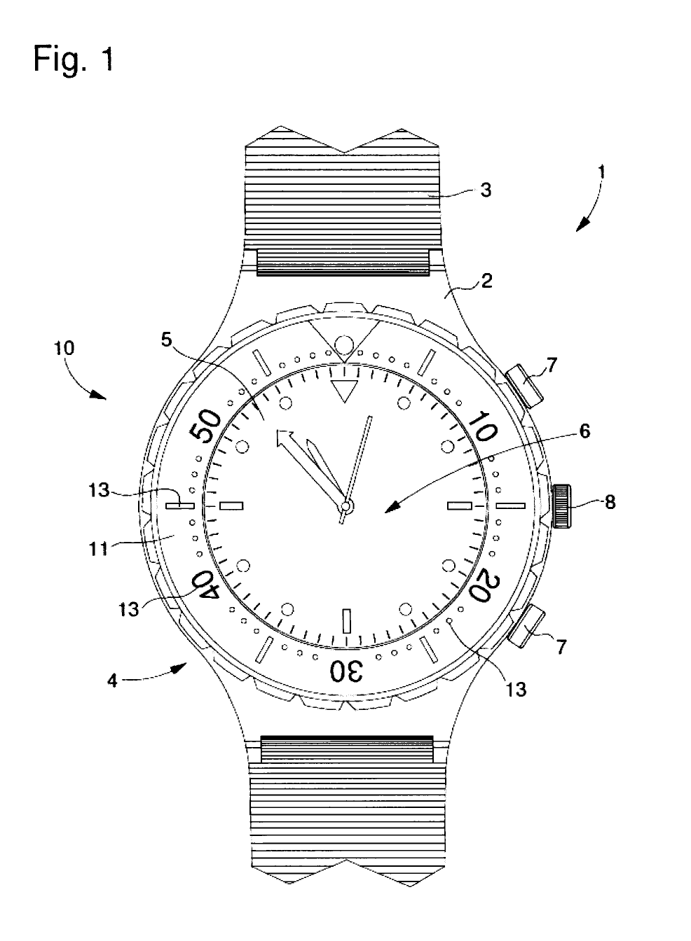

The example illustrated in FIG. 1 shows a timepiece, generally referenced 1, including at least one inlaid element 10. Each inlaid element 10 is intended to form a wear-resistant part including at least one decoration 13, also made of ceramic material, whose visual quality is improved, particularly in terms of contrast and which has very high, homogeneous wear-resistance.

The inlaid element 10 according to the invention may form either all or part of the exterior of timepiece 1. Thus, it could form all or part of a case 2, a bracelet 3, a bezel 4, a dial 5, a crystal 6, a push button 7 and/or a crown 8. In the, example illustrated below, the explanation of the invention will be given with reference to a ring 10 including inlaid decorations 13, forming the graduations of a bezel 4. It is also possible to form inlaid elements 10 for a timepiece movement, such as, for example, a bridge, a main plate, a balance spring, an impulse pin, a balance, a staff, a roller, pallets, a pin, a pallet-lever, a fork, a pallet-stone, a dart, a wheel set, a wheel, an arbor, a pinion, a winding stem, a bearing-block, a bearing and/or an oscillating weight. By way of example, said at least one of decorations 13 may form all or part of a bearing-block such as, for example, the bearing.

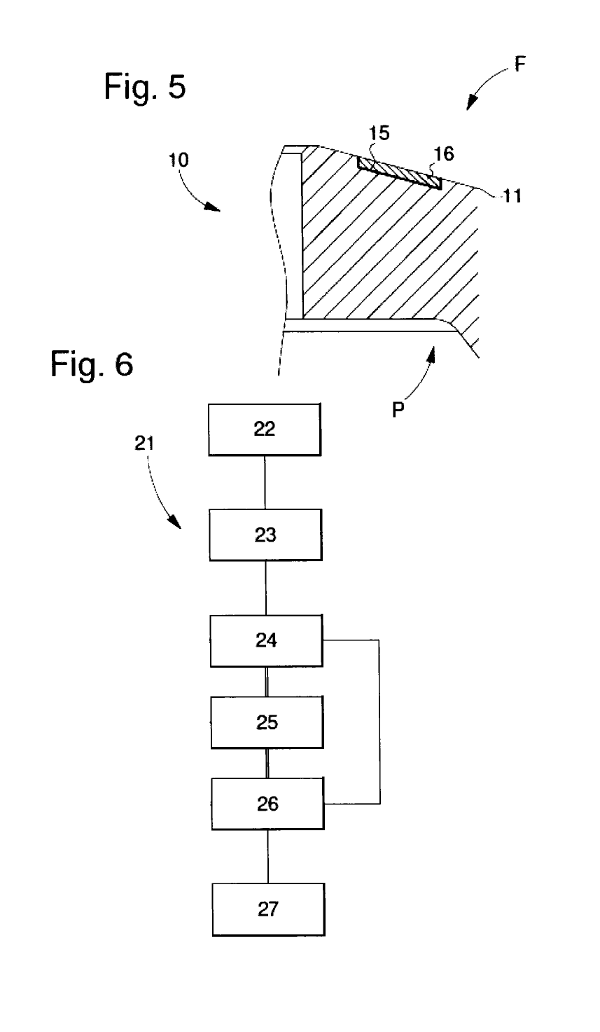

As illustrated in FIGS. 1 and 5, inlaid ceramic element 10 includes a body 11 including at least one recess 12 forming the pattern cavity for a decoration 13. FIG. 1 shows that, advantageously according to the invention, each decoration 13 may take any form, such as, for example, a geometrical figure or an alphanumerical character. According to the invention, each recess 12 is completely filled with at least a second ceramic material 16. This configuration protects each decoration 13 in body 11.

Advantageously according to the invention, said at least one second ceramic material 16 is obtained from a carbide, an oxide or a nitride of materials such as titanium, silicon, aluminium or zirconium, making it possible to obtain a large variety of materials having identical or similar hardness to that of body 11.

Consequently, said at least one second ceramic material 16 and body 11 may be of the same nature, i.e. the same type of ceramic material, but exhibit a difference in composition, such as for example, doping, contrasting the colour of the ceramic materials.

According to the invention, body 11 is obtainable from a large variety of materials. Preferably, body 11 is made of ceramic material. It may therefore be formed by a cermet, which is a material formed of a mixture of ceramic material and metal or by another artificial corundum, such as a single crystal sapphire or a single crystal ruby. More generally, it is possible, by way of example, to use a carbide, an oxide or a nitride of materials such as titanium, silicon, aluminium or zirconium in polycrystalline or single crystal form, to form all or part of body 11. Body 11 may thus, for example, be a watch crystal made of single crystal sapphire including at least one decoration made of a second ceramic material depicting a trademark or a display element, such as an hour-circle.

In order to improve the adherence of decoration 13 in body 11, recess 12 has a depth of between 80 μm et 700 μm and preferably, substantially equal to 400 μm. It is thus understood that, preferably, recess 12 does not open onto the opposite face P.

Further, for reasons of adherence of said at least one second ceramic material 16, preferably, each bottom of said at least one recess 12 has a changed surface state in order to increase the contact surface thereof. As explained below, the increase in surface may be obtained, in particular, by forming cavities in said bottom of said at least one recess or by locally increasing the roughness thereof.

Finally, as seen in FIG. 5, optionally, a connecting layer 15, of between 2 μm and 150 μm, may be formed between the bottom of said at least one recess and said at least one second ceramic material 16 in order to ensure improved adherence of decoration 13. By way of example, connecting layer 15 may be formed from a printing technique so as to continuously cover the bottom of said at least one recess. This technique may consist, in particular, of pad printing, sputtering or application by roller or brush.

This layer 15 may include, in particular, a metal such as chromium or titanium and/or a metal alloy and/or a metal nitride such as chromium nitride, and/or a metal carbide and/or a titanate and/or a zirconate and/or an aluminate. During development, the utilisation of this type of layer 15 never proved necessary for the ceramic materials tested, since adhesion tests are were already satisfactory without layer 15.

Thus, according to the invention, the visual rendering of each decoration 13 is obtained via the colour of said at least one second ceramic material 16. Consequently, the material used for said at least one second ceramic material 16 will preferably be guided by its colour, or more generally, its aesthetic appearance. By way of example, it is therefore possible to obtain a highly contrasted visual rendering with a dark-coloured body 11 and decorations 13 in one (or more) light colour(s), all made of ceramic material.

Consequently, the optional connecting layer 15 may also be used for its colour. Indeed, the colour may be selected or changed to modify the appearance of said at least one second ceramic material 16. Indeed, the thickness of said at least one second deposited ceramic material 16 may, depending on the application, make render the latter substantially translucent. Consequently, an optional connecting layer 15 may be used so that its colour is perceptible through said at least one second ceramic material 16. Thus, by way of example, a colour pigment or a particular material could be chosen for optional connecting layer 15 in order to change the substantially translucent appearance of said at least one second ceramic material 16.

It is understood that decorations 13 may be formed using the same material to offer a homogeneous appearance or several different materials in order, for example, to give two decorations 13 a different colour, such as a first colour for the indices and another colour for the alphanumerical characters in the case of FIG. 1.

In order to make the colours uniform, it is also possible to envisage forming decorations 13 in the same material as that surrounding body 11. Thus, in the embodiment example in FIG. 1, it would be possible to have decorations 13 of bezel 4 made of the same material as case 2, bracelet 3, the remainder of bezel 4, dial 5, push-pieces 7, or crown 8, and also a watch middle part, a horn, a flange, a case back cover, a hand, a link, a clasp, a decoration and/or an applique.

The method 21 of manufacturing an inlaid element 10 will now be explained with reference to FIGS. 2 to 6 using the example of a ceramic body 11.

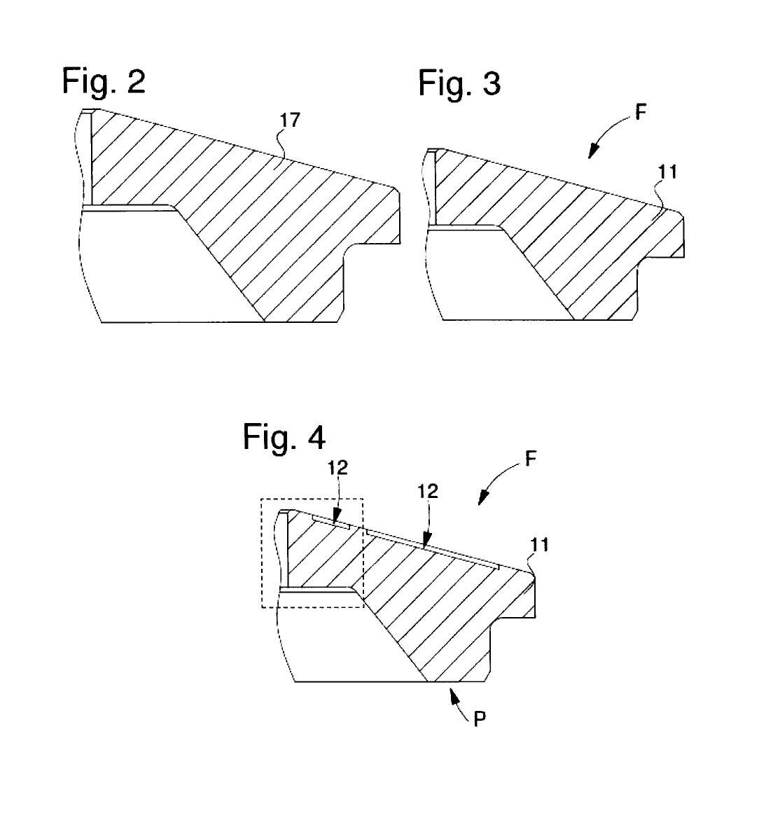

In a first step 22 illustrated in FIG. 6, method 21 consists in forming body 11, for example, of zirconia or alumina. As is partially shown by the change from FIG. 2 to FIG. 3, the final body 11 of step 22 is preferably obtained by sintering, i.e. from a green body 17 preformed via an injection and/or pressing process. At the end of step 22, the body 11 visible in FIG. 3 has its final dimensions.

Of course, step 22 may be obtained other than by sintering. Thus, for example, when body 11 is formed from a single crystal ceramic base, such as an artificial corundum, body 11 will use a different technique. By way of example, after forming a boule of single crystal ceramic material, the boule could be cut and then the shape of the body machined into the cut wafer. More generally, steps such as machining and/or lapping and/or polishing may be performed.

As illustrated in FIG. 6, method 21 includes a second step 23, intended to etch at least one blind recess 12, in one face F of ceramic body 11, with recesses 12 forming the pattern cavity for future decorations 13 as visible in FIG. 4. Preferably, each recess 12 has a depth of between 80 μm and 700 μm. Step 23 is preferably obtained by destructive radiation using a laser to obtain proper etching precision.

In the example of FIG. 3, face F is substantially rectilinear and extends annularly. It is thus easily understood that face F may have a different geometry without making the method more difficult to implement. Thus, by way of example, it is perfectly possible for face F to be partially or totally convex and to extend in translation or rotation to form, for example, a face F that is partially or totally spherical, toroidal or cylindrical.

As illustrated in FIG. 6, method 21 continues with a third step 24 intended to change the surface state of the bottom of said at least one recess 12, so as to increase the contact surface thereof. Preferably, step 24 forms cavities in the bottom of said at least one recess or merely increases its local roughness.

The cavities or roughness may have depths which are preferably not more than one fifth of the depth of recesses 12, in order to increase the contact surface. Step 24 is preferably obtained by destructive radiation using a laser, by sandblasting or by chemical etching.

By way of example, tests were performed using recesses 12 having a depth of 400 μm. The cavities were made by destructive radiation, forming a first series of substantially parallel, rectilinear grooves which intersects with a second series of substantially parallel, rectilinear grooves. The depth of the cavities was modulated between 10 and 50 μm each time proving satisfactory as regards the adherence of decoration 13 to body 11. Consequently, the cavities may form grooves running on said bottom of said at least one recess and all or part of the grooves may be secant.

Of course, it would also be possible to envisage roughly forming a hole in a mould followed by a laser finishing operation to obtain the same etching precision. The object is to improve adherence by an increase in surface, without, however, adversely affecting the wettability of the materials which have to fill each recess.

In a first embodiment, seen in double lines in FIG. 6, step 24 continues with step 25 of method 21 consisting in forming a connecting layer 15 on the bottom of said at least one recess, in order to ensure improved adherence or to change the aesthetic appearance of the future at least one second ceramic material 16 formed in step 26. This first embodiment concerns the case where the material of decoration 13 is formed by said at least one second ceramic material 16 and, optionally, connecting layer 15, as visible in FIG. 5.

Step 25 may be formed by a dry or wet deposition possible requiring subsequent activation using a heat and/or drying treatment. This type of connecting layer 15 may, for example, be formed from a metal, a metal alloy, a metal nitride, a metal carbide, a zirconate, a titanate and/or an aluminate. In the first embodiment, after step 25, method 21 continues with step 26.

In a second embodiment, seen in a single line in FIG. 6, step 24 is immediately followed by step 26. This second embodiment is preferred and concerns the case where the material of decoration 13 is formed only by said at least one second ceramic material 16.

Step 26 consists in filling said at least one recess 12 with said at least one second ceramic material 16 in order to form said decoration. Preferably, step 26 consists in depositing, by thermal spraying, said at least one second ceramic material 16 above said at least one recess 12 in order to entirely fill said at least one recess 12.

There exist several types of thermal spraying such as, in a non-limiting manner, flame spraying, high velocity oxy-fuel coating spraying or plasma spraying. The object of these methods is to melt an additional material and then spray it onto the target surface to form a thick, homogeneous layer of additional material.

Preferably, the thermal spraying is plasma spraying, since it gives excellent results for ceramic deposition. More specifically, tests proved totally satisfactory with thermal spraying using air at atmospheric pressure as the spraying medium for the deposition of an alumina. More generally, it became clear that thermal spraying may be performed under air for oxides and in a vacuum for carbides or nitrides.

Movement of body 11 with respect to the thermal spraying device, may optionally be envisaged to improve the filling of said at least one recess 12.

Preferably according to the invention, the additional materials may be formed from a carbide, an oxide or a nitride of materials such as titanium, silicon, aluminium or zirconium to form all or part of decoration 13. It is thus understood that these particles may or may not be from the same family as that of body 11.

As explained above, depending on the desired colour or more generally visual rendering, the second ceramic material(s) 16 formed in step 26 preferably include(s) one or more colours contrasting with that of body 11.

Finally, in a last step 27, method 21 ends with the flattening of each at least one second ceramic material 16 so as that it remains only in the hollow of each recess 12. Inlaid element 10 is thus finished and simply requires assembly in a final part. This step 27 can be obtained by a usual surfacing method such as grinding or lapping to remove any surplus material, followed by polishing.

During one of the tests, a black zirconium bezel was developed whose decorations 13 form white alumina indices, which proved entirely satisfactory with its homogeneous “ceramic” appearance, its very high, homogeneous hardness and very high contrast.

Of course, this invention is not limited to the illustrated example but is capable of various variants and alterations that will appear to those skilled in the art. In particular, the application of inlaid element 10 according to the invention is in no way limited to a timepiece 1. Thus, inlaid element 10 could, by way of example, be applied to a piece of jewellery or even to tableware.

Further, it is also possible to envisage replacing the laser etching in step 23 and/or the laser etching, sandblasting or chemical etching of step 24 with another type of etching if the precision and reject rate thereof are acceptable.

Further, it is also possible to create decorations including several overlaid and/or adjacent ceramic materials. This type of embodiment may, for example, provide a multi-coloured element. Thus, a second ceramic material having a first colour may be etched, for example by laser, to form a third ceramic material having a second colour. It is thus possible to obtain in the actual decoration, or straddling the body and the decoration, two contrasting colours or one colour with a phosphorescent material such as superluminova®.

It is also understood, in the case where at least one of decorations 13 forms all or part of a bearing, that said at least one second ceramic material 16 may simply be etched to form a bearing of the cup-bearing or pierced stone type.

Finally, it is also to be noted that body 11 is not limited to a ceramic element but more generally to an element made of machinable hard material, i.e. whose hardness is equal to or more than 700 HV.

What is claimed is:

1. A method of manufacturing an inlaid ceramic element for a timepiece comprising the following steps:
a) forming a ceramic body;
b) etching at least one recess in one face of the ceramic body, each at least one recess forming the pattern cavity for a decoration;
c) changing the surface state of the bottom of said at least one recess in order to increase the contact surface thereof;
d) depositing, by thermal spraying, a second ceramic material above said at least one recess in order to totally fill said at least one recess;
e) flattening said second ceramic material so that said second ceramic material remains only in the hollow of said at least one recess.

2. The method according to claim 1, wherein the ceramic body includes a carbide, an oxide or a nitride of titanium, silicon, aluminium or zirconium.

3. The method according to claim 1, wherein the ceramic body is a cermet.

4. The method according to claim 1, wherein step a) is achieved by sintering.

5. The method according to claim 1, wherein the ceramic body is a synthetic corundum.

6. The method according to claim 1, wherein step b) is performed by laser.

7. The method according to claim 1, wherein each at least one recess has a depth comprised between 80 μm and 500 μm in order to improve the force of adherence.

8. The method according to claim 1, wherein step c) is performed by laser.

9. The method according to claim 1, wherein step c) forms cavities in said bottom of said at least one recess.

10. The method according to claim 9, wherein the cavities form grooves running on said bottom of said at least one recess.

11. The method according to claim 10, wherein said grooves running on said bottom of said at least one recess are secant.

12. The method according to claim 9, wherein the cavities have depths which are less than one fifth of the depth of said at least one recess.

13. The method according to claim 1, wherein step c) is performed by sandblasting.

14. The method according to claim 1, wherein step c) is performed by chemical etching.

15. The method according to claim 1, wherein the second ceramic material includes a carbide, an oxide or a nitride of titanium, silicon, aluminium or zirconium.

16. The method according to claims 1, wherein the thermal spraying is of the plasma type.

17. The method according to claim 1, wherein prior to step d), the method further includes the following step:
f) forming a connecting layer on the bottom of said at least one recess in order to achieve improved adherence or to change the aesthetic appearance of the second ceramic material.

18. The method according to of claim 1, wherein, after step e), the method further includes the following steps:
b′) etching at least a second recess in one face of the second ceramic material;
c′) changing the surface state of the bottom of said at least one second recess in order to increase the contact surface thereof;
d′) depositing, by thermal spraying, a third ceramic material above said at least one second recess in order to totally fill said at least one second recess;
e′) flattening said third ceramic material so that said third ceramic material remains only in the hollow of said at least one second recess.

19. A timepiece wherein the timepiece includes at least one ceramic element inlaid with at least one decoration including at least a second ceramic material obtained from the method according to claim 1, the ceramic body of said element forming an external part of said timepiece.

20. The timepiece according to claim 19, wherein the ceramic element forms all or part of a case, a bracelet, a bezel, a dial, a crystal, a push-piece, a crown, a watch middle part, a horn, a flange, a case back cover, a hand, a link, a clasp, a decoration and/or an applique.

21. A timepiece wherein the timepiece includes at least one ceramic element inlaid with at least one decoration including at least one second ceramic material obtained from the method according to claim 1, the ceramic body of said element forming a part of the movement of said timepiece.

22. The timepiece according to the claim 21, wherein the ceramic element forms all or part of a balance spring, an impulse pin, a balance, a staff, a roller, pallets, a pin, a pallet-lever, a fork, a pallet-stone, a dart, a wheel set, a wheel, an arbor, a pinion, a bridge, a main plate, an oscillating weight, a winding stem, a bearing or a bearing-block.
